(19) United States
(12) Patent Application Publication
(10) Pub. No.: US 2023/0127310 A1
(43) Pub. Date: Apr. 27, 2023

(54) METHOD AND APPARATUS FOR DETECTING MULTIPATH SIGNALS FROM A NAVIGATION SATELLITE

(71) Applicant: HERE GLOBAL B.V., Eindhoven (NL)

(72) Inventors: Saara Kuismanen, Tampere (FI); Pekka-Henrik Niemenlehto, Nokia (FI)

(73) Assignee: HERE GLOBAL B.V., Eindhoven (NL)

(21) Appl. No.: 17/508,297

(22) Filed: Oct. 22, 2021

(51) Int. Cl. G01S 19/42

(52) U.S. Cl. CPC G01S 19/428

(57) ABSTRACT

A method, apparatus and computer program product are provided for detecting multipath signals from a navigation satellite. In the context of a method, the method includes obtaining a measurement of a parameter based on signals transmitted by the navigation satellite and received by a navigation device and determining an estimated position of the navigation device upon receiving the signals. Based on navigation data regarding a position of the navigation satellite and correction data regarding a correction to the position of the navigation satellite, the method also includes determining a virtual observation for the parameter. The virtual observation is determined for the navigation device being located at the estimated position. The method further includes determining whether the signals transmitted by the navigation satellite and received by the navigation device include multipath signals based upon the measurement of the parameter and the virtual observation for the parameter.

### TECHNOLOGICAL FIELD

An example embodiment relates generally to the detection of multipath signals from a navigation satellite such that action may be taken, such as the provision of a warning indication and/or the determination of a refined position in a manner that reduces or eliminates reliance upon the multipath signals.

### BACKGROUND

Positioning and navigation solutions commonly depend upon a Global Navigation Satellite System (GNSS) with signals transmitted by a GNSS satellite being received by GNSS receivers embedded in or otherwise carried by a variety of different devices. For example, smartphones, smart watches, vehicles, drones and other location-aware devices include GNSS receivers in order to allow the position of the device to be determined. In some instances, the device may include a navigation system and/or a navigation application that is dependent upon the signals received by the GNSS receiver in order to determine the position of the device and to provide navigational assistance. The number of devices that include GNSS receivers is growing rapidly with more types of devices including devices, such as Internet of Things (IOT) devices, with limited amounts of computational resources including GNSS receivers.

The GNSS family includes several satellite constellations including the Global Positioning System (GPS) and the Globalnaya Navigatsionnaya Sputnikovaya Sistema (GLONASS) system. Other GNSS satellite constellations include the Beidou system and the Galileo system. In addition to these global satellite constellations, several regional Satellite-Based Augmentation Systems (SBAS), such as the Quazi-Zenith Satellite System (QZSS), Multifunctional Transport Satellites (MTSAT) Satellite Augmentation System (MSAS), Wide Area Augmentation System (WAAS), European Geostationary Navigation Overlay Service (EGNOS), GPS-Aided Geostationary (GEO) Augmented Navigation (GAGAN), System for Differential Correction and Monitoring (SDCM) and the Indian Regional Navigation Satellite System (IRNSS) having an operational name of NavIC (Navigation with Indian Constellation), have been developed.

In a GNSS system, a navigation satellite orbiting the Earth transmits navigation signals including ranging codes and navigation data interleaved with the ranging codes that a GNSS receiver receives and utilizes to determine the position of the GNSS receiver and, in turn, the device in which the GNSS receiver is embedded. The ranging code allows the GNSS receiver to determine the time required for the signals to travel from the navigation satellite to the GNSS receiver, which correlates to the distance between the navigation satellite and the GNSS receiver. The navigation data includes a set of parameter values of an orbit model defining the orbit of the navigation satellite for a limited period of time. The parameter values are known as ephemeris data. The ephemeris data may be utilized by the GNSS receiver to determine the position the navigation satellite relative to a predefined coordinate system at particular instances of time. Based on the positions of a plurality of navigation satellites, clock information of the navigation satellites, such as the clock offsets of the navigation satellites relative to GNSS time, and the time required for the signals broadcast by the navigation satellites to be received by the GNSS receiver, the GNSS receiver is configured to determine its position.

The signals transmitted by navigation satellites typically have a predefined transmission power. Prior to being received by a GNSS receiver, however, the signals transmitted by a navigation satellite generally lose power due to interaction of the signals with the atmosphere through which the signals travel, interaction of the signals with various obstructions, such as trees, and the reflectance of the signals from a surface, such as a building, a body of water or the like, resulting in the creation of multipath signals. The creation of multipath signals and the resulting loss of power is particularly notable in environments, such as urban canyons, in which the GNSS receiver is in the midst of one or more relatively tall buildings.

Multipath signals that are reflected from a surface prior to being received by a GNSS receiver will take longer to travel from the navigation satellite to the GNSS receiver and will have travelled a longer distance in comparison to signals transmitted by the same navigation satellite at the same time that travel directly along a line-of-sight to the GNSS receiver. As such, multipath signals will adversely affect the position that is determined based upon the reception of signals by the GNSS receiver as a result of the longer time and greater distance travelled by the multipath signals.

As a result, techniques have been developed in an effort to detect multipath signals and to determine the position of a GNSS receiver that receives multipath signals in a more accurate manner. A number of these techniques for detecting and compensating for multipath signals are computationally complex and may require access to large data sources, such as data sources providing three dimensional maps of a region, including three dimensional models of buildings within the region. Other techniques for detecting and addressing multipath signals may require the GNSS receiver to have a more sophisticated antenna suite and/or may require access to the antennas and the underlining signal processing algorithms. As such, the techniques for detecting and addressing multipath signals may not be appropriate for a number of GNSS receivers, such as GNSS receivers that do not have sufficient processing resources, that lack access to the large data sources including three dimensional maps and/or that do not have the antennas required to detect and address the multipath signals.

### BRIEF SUMMARY

A method, apparatus and computer program product are therefore provided in accordance with an example embodiment in order to detect multipath signals. By detecting multipath signals, the method, apparatus and computer program product may take action to reduce or eliminate the reliance upon multipath signals in conjunction with the determination of the position of the GNSS receiver. In accordance with an example embodiment, the method, apparatus and computer program product efficiently detect multipath signals without requiring substantial computational complexity, without requiring access to navigational data sources including three dimensional maps of the region including three dimensional models of buildings within the region and/or with requiring sophisticated antennas. As such, the method, apparatus of the computer program product of an example embodiment may be implemented by a wide variety of devices, including those devices that have more limited amount of computational resources.

In an example embodiment, a method is provided for detecting multipath signals from a navigation satellite. The method includes obtaining a measurement of a parameter, such as one or more of a pseudorange between the navigation satellite and the navigation device, a carrier phase of the signals or a doppler shift of the signals, based on signals transmitted by the navigation satellite and received by a navigation device and determining an estimated position of the navigation device upon receiving the signals. Based on navigation data regarding a position of the navigation satellite and correction data regarding a correction to the position of the navigation satellite, the method also includes determining a virtual observation for the parameter. The virtual observation is determined for the navigation device being located at the estimated position. The method further includes determining whether the signals transmitted by the navigation satellite and received by the navigation device include multipath signals based upon the measurement of the parameter and the virtual observation for the parameter.

In an example embodiment, the method determines whether the signals transmitted by the navigation satellite and received by the navigation device include multipath signals by comparing a difference between the measurement of the parameter and the virtual observation for the parameter to a threshold, such as an adaptive threshold at least partially based upon one or more of a quality of the signals received by a navigation device from the navigation satellite, a type of navigation device, one or more characteristics of the navigation device or a number of navigation satellites of a constellation transmitting signals that are received by the navigation device. The measurement of the parameter may be repeatedly obtained over time and the virtual observation for the parameter may be repeatedly determined over time. In this example embodiment, the method compares the difference by comparing (i) a difference between an average of the measurement of the parameter obtained over time and an average of the virtual observation for the parameter determined over time to (ii) the threshold.

The method of an example embodiment also includes causing a warning indication to be provided in response to the signals transmitted by the navigation satellite and received by the navigation device being determined to comprise multipath signals. In an example embodiment, the method also includes determining a refined position of the navigation device based upon signals transmitted by a plurality of navigation satellites and received by the navigation device but without consideration of the signals transmitted by the navigation satellite that were determined to comprise multipath signals. The method of an example embodiment also includes compensating for a delay introduced into the signals transmitted by the navigation satellite and received by the navigation device as a result of multipath propagation of the signals that were determined to comprise multipath signals and determining a refined position of the navigation device based upon the signals transmitted by the navigation satellite following compensation for the delay introduced by the multipath propagation. In an example embodiment, the method also includes determining a refined position of the navigation device in accordance a different positioning technique that does not rely upon the signals transmitted by the navigation satellite in an instance in which the signals transmitted by the navigation satellite are determined to comprise multipath signals.

In another example embodiment, an apparatus is provided that is configured to detect multipath signals from a navigation satellite. The apparatus includes processing circuitry and at least one non-transitory memory including computer program code instructions stored therein with the computer program code instructions configured to, when executed by the processing circuitry, cause the apparatus at least to obtain a measurement of a parameter, such as one or more of a pseudorange between the navigation satellite and the navigation device, a carrier phase of the signals or a doppler shift of the signals, based on signals transmitted by the navigation satellite and received by a navigation device and to determine an estimated position of the navigation device upon receiving the signals. Based on navigation data regarding a position of the navigation satellite and correction data regarding a correction to the position of the navigation satellite, the computer program code instructions are also configured to, when executed by the processing circuitry, cause the apparatus to determine a virtual observation for the parameter. The virtual observation is determined for the navigation device being located at the estimated position. The computer program code instructions are further configured to, when executed by the processing circuitry, cause the apparatus to determine whether the signals transmitted by the navigation satellite and received by the navigation device include multipath signals based upon the measurement of the parameter and the virtual observation for the parameter.

The computer program code instructions are configured to, when executed by the processing circuitry, cause the apparatus of an example embodiment to determine whether the signals transmitted by the navigation satellite and received by the navigation device comprise multipath signals by comparing a difference between the measurement of the parameter and the virtual observation for the parameter to a threshold, such as an adaptive threshold at least partially based upon one or more of a quality of the signals received by a navigation device from the navigation satellite, a type of navigation device, one or more characteristics of the navigation device or a number of navigation satellites of a constellation transmitting signals that are received by the navigation device. In an example embodiment in which the measurement of the parameter is repeatedly obtained over time and the virtual observation for the parameter is repeatedly determined over time, the computer program code instructions are configured to, when executed by the processing circuitry, cause the apparatus to compare the difference by comparing (i) a difference between an average of the measurement of the parameter obtained over time and an average of the virtual observation for the parameter determined over time to (ii) the threshold.

The computer program code instructions are further configured to, when executed by the processing circuitry, cause the apparatus of an example embodiment to cause a warning indication to be provided in response to the signals transmitted by the navigation satellite and received by the navigation device being determined to comprise multipath signals. In an example embodiment, the computer program code instructions are further configured to, when executed by the processing circuitry, cause the apparatus to determine a refined position of the navigation device based upon signals transmitted by a plurality of navigation satellites and received by the navigation device but without consideration of the signals transmitted by the navigation satellite that were determined to comprise multipath signals. The computer program code instructions are further configured to, when executed by the processing circuitry, cause the apparatus of an example embodiment to compensate for a delay introduced into the signals transmitted by the navigation satellite and received by the navigation device as a result of multipath propagation of the signals that were determined to comprise multipath signals and to determine a refined position of the navigation device based upon the signals transmitted by the navigation satellite following compensation for the delay introduced by the multipath propagation. In an example embodiment, the computer program code instructions are further configured to, when executed by the processing circuitry, cause the apparatus to determine a refined position of the navigation device in accordance a different positioning technique that does not rely upon the signals transmitted by the navigation satellite in an instance in which the signals transmitted by the navigation satellite are determined to comprise multipath signals.

In a further example embodiment, a computer program product is provided that is configured to detect multipath signals from a navigation satellite. The computer program product include at least one non-transitory computer-readable storage medium having computer-executable program code instructions stored therein with the computer-executable program code instructions including program code instructions configured to obtain a measurement of a parameter, such as one or more of a pseudorange between the navigation satellite and the navigation device, a carrier phase of the signals or a doppler shift of the signals, based on signals transmitted by the navigation satellite and received by a navigation device and to determine an estimated position of the navigation device upon receiving the signals. The computer-executable program code instructions also include program coded instructions configured to determine a virtual observation for the parameter based on navigation data regarding a position of the navigation satellite and correction data regarding a correction to the position of the navigation satellite. The virtual observation is determined for the navigation device being located at the estimated position. The computer-executable program code instructions further include program code instructions configured to determine whether the signals transmitted by the navigation satellite and received by the navigation device include multipath signals based upon the measurement of the parameter and the virtual observation for the parameter.

In an example embodiment, the program code instructions configured to determine whether the signals transmitted by the navigation satellite and received by the navigation device include multipath signals include program code instructions configured to compare a difference between the measurement of the parameter and the virtual observation for the parameter to a threshold, such as an adaptive threshold at least partially based upon one or more of a quality of the signals received by a navigation device from the navigation satellite, a type of navigation device, one or more characteristics of the navigation device or a number of navigation satellites of a constellation transmitting signals that are received by the navigation device. The measurement of the parameter may be repeatedly obtained over time and the virtual observation for the parameter may be repeatedly determined over time. In this example embodiment, the program code instructions configured to compare the difference include program code instructions configured to compare (i) a difference between an average of the measurement of the parameter obtained over time and an average of the virtual observation for the parameter determined over time to (ii) the threshold.

The computer-executable program code instructions of an example embodiment also include program code instructions configured to cause a warning indication to be provided in response to the signals transmitted by the navigation satellite and received by the navigation device being determined to comprise multipath signals. In an example embodiment, the computer-executable program code instructions additionally include program code instructions configured to determine a refined position of the navigation device based upon signals transmitted by a plurality of navigation satellites and received by the navigation device but without consideration of the signals transmitted by the navigation satellite that were determined to comprise multipath signals. The computer-executable program code instructions of an example embodiment further include program code instructions configured to compensate for a delay introduced into the signals transmitted by the navigation satellite and received by the navigation device as a result of multipath propagation of the signals that were determined to comprise multipath signals and determine a refined position of the navigation device based upon the signals transmitted by the navigation satellite following compensation for the delay introduced by the multipath propagation. In an example embodiment, the computer-executable program code instructions also include program code instructions configured to determine a refined position of the navigation device in accordance a different positioning technique that does not rely upon the signals transmitted by the navigation satellite in an instance in which the signals transmitted by the navigation satellite are determined to comprise multipath signals.

In yet another example embodiment, an apparatus is provided configured to detect multipath signals from a navigation satellite. The apparatus includes means for obtaining a measurement of a parameter, such as one or more of a pseudorange between the navigation satellite and the navigation device, a carrier phase of the signals or a doppler shift of the signals, based on signals transmitted by the navigation satellite and received by a navigation device and means for determining an estimated position of the navigation device upon receiving the signals. Based on navigation data regarding a position of the navigation satellite and correction data regarding a correction to the position of the navigation satellite, the apparatus also includes means for determining a virtual observation for the parameter. The virtual observation is determined for the navigation device being located at the estimated position. The apparatus further includes means for determining whether the signals transmitted by the navigation satellite and received by the navigation device include multipath signals based upon the measurement of the parameter and the virtual observation for the parameter.

In an example embodiment, the means for determining whether the signals transmitted by the navigation satellite and received by the navigation device include multipath signals include means for comparing a difference between the measurement of the parameter and the virtual observation for the parameter to a threshold, such as an adaptive threshold at least partially based upon one or more of a quality of the signals received by a navigation device from the navigation satellite, a type of navigation device, one or more characteristics of the navigation device or a number of navigation satellites of a constellation transmitting signals that are received by the navigation device. The measurement of the parameter may be repeatedly obtained over time and the virtual observation for the parameter may be repeatedly determined over time. In this example embodiment, the means for comparing the difference include means for comparing (i) a difference between an average of the measurement of the parameter obtained over time and an average of the virtual observation for the parameter determined over time to (ii) the threshold.

The apparatus of an example embodiment also includes means for causing a warning indication to be provided in response to the signals transmitted by the navigation satellite and received by the navigation device being determined to comprise multipath signals. In an example embodiment, the apparatus also includes means for determining a refined position of the navigation device based upon signals transmitted by a plurality of navigation satellites and received by the navigation device but without consideration of the signals transmitted by the navigation satellite that were determined to comprise multipath signals. The apparatus of an example embodiment also includes means for compensating for a delay introduced into the signals transmitted by the navigation satellite and received by the navigation device as a result of multipath propagation of the signals that were determined to comprise multipath signals and means for determining a refined position of the navigation device based upon the signals transmitted by the navigation satellite following compensation for the delay introduced by the multipath propagation. In an example embodiment, the apparatus also includes means for determining a refined position of the navigation device in accordance a different positioning technique that does not rely upon the signals transmitted by the navigation satellite in an instance in which the signals transmitted by the navigation satellite are determined to comprise multipath signals.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 illustrates a system in which navigation-data parameters and/or correction-model parameters are provided to a navigation device based on navigation data provided by a navigation satellite as well as correction data in accordance with an example embodiment;

FIG. 2 is a block diagram of an apparatus that may be specifically configured in accordance with an example embodiment of the present disclosure;

FIG. 3 is a flowchart illustrating the operations performed, such as by the apparatus of FIG. 2, in accordance with an example embodiment of the present disclosure; and

FIG. 4 is another block diagram of an apparatus in accordance with an example embodiment of the present disclosure which depicts at least some of the operations performed by the apparatus.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are disclosed for detecting multipath signals, such as signals transmitted by a navigational satellite that reflect from a surface, such as the surface of a building, the surface of a body of water or the like, prior being received, such as by a receiver, e.g., a GNSS receiver, of a navigation device. By detecting the multipath signals, the position of the receiver may be determined in a more accurate manner by reducing or eliminating the reliance upon the multipath signals in conjunction with the determination of the position of the receiver. Additionally or alternatively, a warning indication may be provided in an instance in which at least some of the signals received by the receiver and utilized to determine the position of the receiver are multipath signals, thereby providing a forewarning as to potential inaccuracies introduced by the multipath signals in conjunction with the determination of the position of the receiver and any navigational functions that are premised upon the position of the receiver.

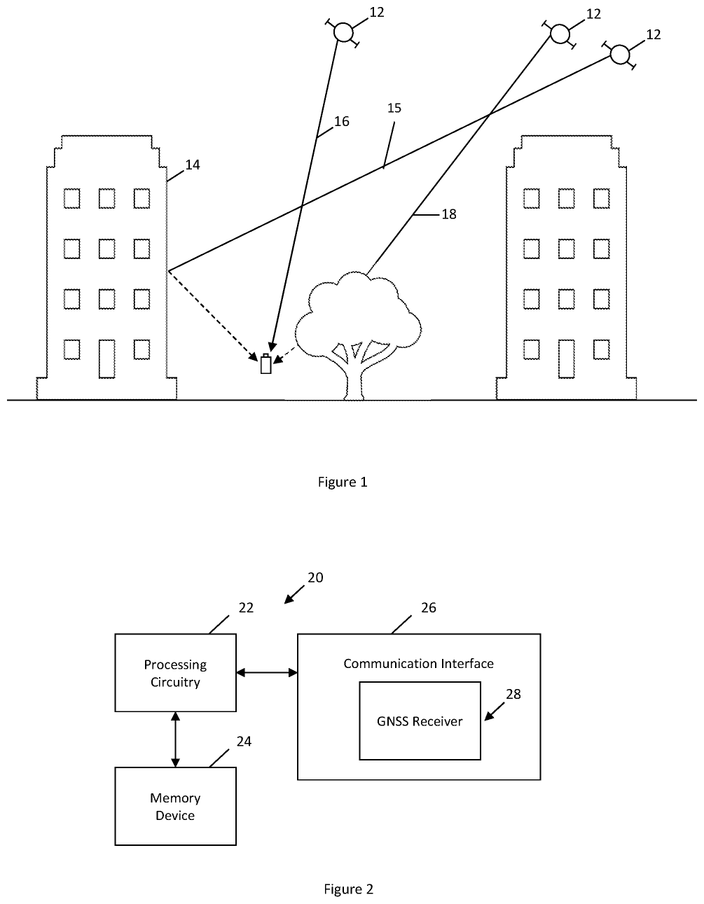

Referring now to FIG. 1, a navigation device 10 is depicted to receive data broadcast by the navigation satellites. Although three navigation satellites are depicted for purposes of illustration, the navigation device may receive data broadcast by any number of navigation satellites of a constellation of navigation satellites that orbit the earth. For example, the navigation satellite may be a GNSS satellite, such as a GPS satellite, a GLONASS satellite, a Beidou satellite, a Galileo satellite or a regional SBAS satellite. Regardless of the type of navigation satellite, the navigation satellites provide signals, such as on a periodic basis, that includes a ranging code and ephemeris data interleaved with the ranging code that defines the orbit of the navigation satellite for the lifetime of the ephemeris data, such as for a predefined period of time, e.g., 2 to 4 hours. Based upon the ephemeris data, the position of the navigation satellite may be determined within the predefined period of time.

Although FIG. 1 depicts a single navigation device 10, the navigation satellite 12 may broadcast data that is received by a plurality of navigation devices in other embodiments. The navigation device may be embodied by any of a variety of devices including, for example, a mobile device, such as a mobile terminal, e.g., a personal digital assistant (PDA), mobile telephone, smart phone, personal navigation device, smart watch, tablet computer, or any combination of the aforementioned and other types of portable computer devices including an IOT device that includes a GNSS receiver, or a positioning or navigation system such as a positioning or navigation system onboard a vehicle, e.g., an automobile, a truck, a drone, a train, etc. Regardless of the manner in which the navigation device is embodied, the navigation device is generally configured to predict the position of the navigation satellite, such as the orbit and/or the clock offset of the navigation satellite, at one or more points in time within a prediction interval. The prediction interval may optionally extend temporally beyond a predefined period of time during which the ephemeris data is valid so as to predict the position of the navigation satellite at each of a plurality of points in time following the lifetime of the ephemeris data. Although the navigation device may be configured to predict the position of the navigation satellite at the plurality of points in time within the prediction interval in any of a variety of different manners, the navigation device of an example embodiment is configured to predict the position of the navigation satellite utilizing a prediction algorithm, such as a prediction algorithm that provides an ephemeris extension of the ephemeris data.

In this regard, an Ephemeris Extension Service (EES) is available to extend the useful lifespan of the ephemeris data with the extension based on a model of the orbit of the navigation satellite and, in some instances, the clock on-board of the navigation satellite. In a typical EES system, the orbit of a navigation satellite 12 is predicted by integrating output values of an equation of motion defined for the satellite. The last reliable position of the satellite that can be determined with the ephemeris data may be utilized as an initial state of the orbit for the integration. The equation of motion may be referenced as a force model, as the equation is based on forces acting upon the satellite. Although the orbit of the satellite may be predicted most accurately by including all forces that have a distinguishable effect upon the satellite, the equation of motion generally includes only the forces that contribute most significantly to the position of the satellite, such as by including the gravitational forces of the earth, the sun and the moon, as well as solar radiation pressure.

Several Ephemeris Extension Services are available including the ephemeris extension technology included in the 3rd Generation Partnership Project (3GPP) standards beginning with Release8 and available for GPS, GLONASS and Galileo systems. This ephemeris extension technology provides differential corrections to a reference ephemeris. In addition, other types of Ephemeris Extension Services that are available include those provided by the HERE GNSS API from HERE Technologies as well as GPSOneXtra from Qualcomm Technologies, Inc., Long-Term Orbit (LTO) from Broadcom Inc. and Predicted GPS (PGPS) from RX Networks, Inc. These other types of Ephemeris Extension Services also allow the ephemeris lifetime to be extended, such as for several days or even weeks.

As also shown in FIG. 1, at least some of the signals transmitted by the navigation satellite 12 do not travel directly to the navigation device 10, but, instead, are reflected from a surface, such as the surface of a building 14 as shown in FIG. 1 or another surface, such as the surface of a body of water. These signals constitute multipath signals 15. In contrast, some of the signals transmitted by the navigation satellite may travel directly along a line-of-sight from the navigation satellite to the navigation device, either in an unimpeded manner as illustrated by signal 16 or following propagation through an obstructions, such as a tree, that causes the loss of some power as illustrated by signal 18. Although both signals that travel directly along a line-of sight and multipath signals are received by the navigation device, the signals that travel along the line-of-sight provide more accurate information regarding the time required for the signals to travel from the navigation satellite to the navigation device and, as a result, provide more accurate information regarding the distance between the navigation satellite and the navigation device in comparison to a multipath signal that travels a longer distance and requires a longer period of time to travel from the navigation satellite to the navigation device.

In order to determine the position of the navigation device 10 with more accuracy in an environment in which multipath signals 15 are generated, an apparatus 20 is provided in accordance with an example embodiment to detect the multipath signals. As shown in FIG. 2, the apparatus includes processing circuitry 22, a memory device 24 and a communication interface 26.

In some embodiments, the processing circuitry 22 (and/or co-processors or any other processors assisting or otherwise associated with the processing circuitry) can be in communication with the memory device 24 via a bus for passing information among components of the apparatus 20. The memory device can be non-transitory and can include, for example, one or more volatile and/or non-volatile memories. In other words, for example, the memory device may be an electronic storage device (for example, a computer readable storage medium) comprising gates configured to store data (for example, bits) that can be retrievable by a machine (for example, a computing device like the processing circuitry). The memory device can be configured to store information, data, content, applications, instructions, or the like for enabling the apparatus to carry out various functions in accordance with an example embodiment of the present disclosure. For example, the memory device can be configured to buffer input data for processing by the processing circuitry. Additionally or alternatively, the memory device can be configured to store instructions for execution by the processing circuitry.

The processing circuitry 22 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally or alternatively, the processing circuitry can include one or more processors configured in tandem via the bus to enable independent execution of instructions, pipelining and/or multithreading.

In an example embodiment, the processing circuitry 22 can be configured to execute instructions stored in the memory device 24 or otherwise accessible to the processing circuitry. Alternatively or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 20 of an example embodiment can also include the communication interface 26. The communication interface can be any means such as a device or circuitry embodied in either hardware or a combination of hardware and software that is configured to receive and/or transmit data from/to other electronic devices in communication with the apparatus, such as by providing for communication between the navigation device 10 and one or more other devices. The communication interface can be configured to communicate in accordance with various wireless protocols including Global System for Mobile Communications (GSM), such as but not limited to Long Term Evolution (LTE). In this regard, the communication interface can include, for example, an antenna (or multiple antennas) and supporting hardware and/or software for enabling communications with a wireless communication network. Additionally or alternatively, the communication interface can include the circuitry for interacting with the antenna(s) to cause transmission of signals via the antenna(s) or to handle receipt of signals received via the antenna(s). In some environments, the communication interface can alternatively or also support wired communication. The communication interface may also be configured to support communication with one or more navigation satellites 12. As such, the communication interface of an example embodiment may also include be in communication with a satellite receiver, such as a GNSS receiver 28.

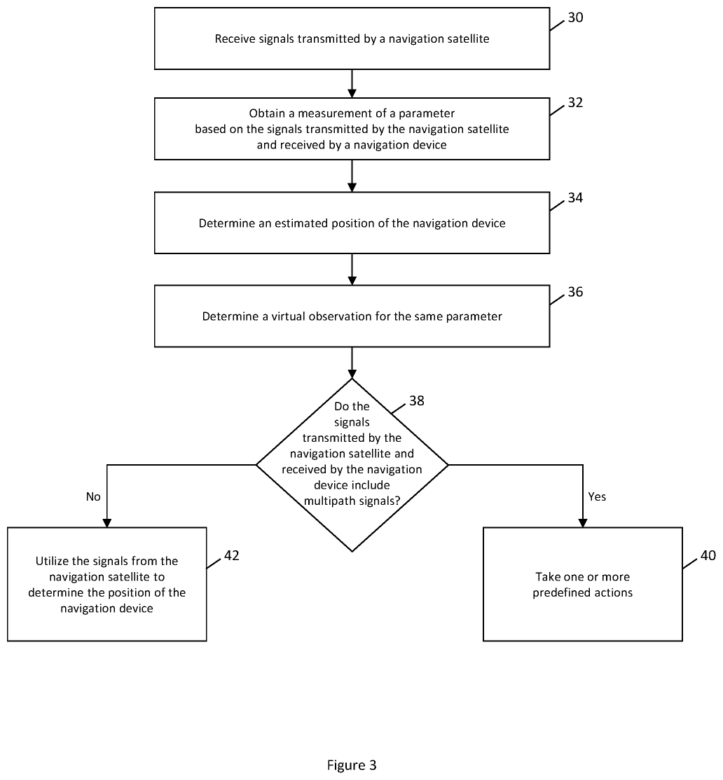

Referring now to FIG. 3, the operations performed, such as by the apparatus 20 of FIG. 2, in accordance with an example embodiment in order to detect multipath signals 15 from a navigation satellite 12 are depicted. Although referenced in conjunction with a single navigation satellite, the same process is separately performed for each of a plurality of navigation satellites that broadcast data received by the navigation device 10. As shown in block 30, the apparatus includes means, such as the processing circuitry 22, the communication interface 26, the GNSS receiver 28 or the like, for receiving signals transmitted by the navigation satellite. The signals that are received may include ranging codes and navigation data, such as ephemeris data. The ephemeris data permits the orbit and, in turn, the position of the satellite to be determined as well as clock information of the satellite, such as the clock offset of the satellite relative to GNSS time, at one or more instances of time throughout the lifetime of the ephemeris data.

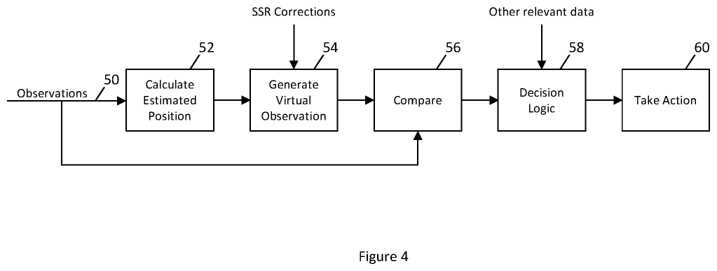

Another example of the operations performed by the apparatus 20 is depicted in FIG. 4 by way of further explanation. As shown in FIG. 4, observations 50 based on the signals transmitted by the navigations satellites 12 are received by a navigation device 10.

As shown in block 32 of FIG. 3, the apparatus also includes means, such as the processing circuitry 22, the communication interface 26 or the like, for obtaining a measurement of a parameter based on signals transmitted by the navigation satellite and received by the navigation device 10, such as by a GNSS receiver 28 of the navigation device. As described below, the parameter for which a measurement is obtained may be a pseudorange between the navigation satellite and the navigation device. In this regard, based upon the time required for the signals transmitted by the navigation satellite to be received by the navigation device, the pseudorange between the navigation satellite and the navigation device may be determined. Although reference to a pseudorange is provided below by way of example of a parameter for which a measurement is obtained based on signals transmitted by navigation satellite and received by the navigation device, a pseudorange is not the only type of parameter for which a measurement may be obtained. In this regard, the carrier phase of the signals transmitted by the navigational satellite and received by the navigation device is another example of a parameter for which a measurement is obtained. Still further, the doppler shift experienced by the signals transmitted by the navigational satellite and received by the navigation device is yet another example of a parameter for which a measurement may be obtained.

As shown in block 34 of FIG. 3 and block 52 of FIG. 4, the apparatus 20 may further include means, such as the processing circuitry 22 or the like, for determining an estimated position of the navigation device 10 upon receiving the signals. By way of example, based upon the pseudoranges that have been determined between a plurality of navigation satellites 12, such as four or more navigation satellites, and the navigation device, the apparatus, such as the processing circuitry, may be configured to determine the estimated position of the navigation device at the time at which the signals transmitted by the navigation satellites were received by the navigation device. Although the estimated position of the navigation device may be determined based upon the signals received by the navigation device from the navigation satellites, the estimated position may alternatively be determined in other manners in other embodiments. For example, the estimated position of the navigation device may be determined at least partially based upon information provided by one or more inertial sensors that indicate the direction and extent of movement of the navigation device from a previous location fix of the navigation device.

The navigation device 10 receives navigation data regarding the position of the navigation satellite 12 and correction data regarding corrections to the position of the navigation satellite. In this regard, the navigation data may define the orbit and, in turn, the position of the navigation satellite as well as the clock offset between the clock of the navigation satellite and the GNSS system clock. Similarly, the correction data may provide corrections to the definitions of the orbit of the navigation satellite and/or corrections to the clock offset of the clock of the navigation satellite relative to the GNSS system clock. The correction data that is considered in some embodiments with respect to the determination of the range between the navigation device and a navigation satellite may also include code biases, phase biases and/or corrections for atmospheric errors, such as ionospheric and/or tropospheric corrections.

The navigation device 10 may receive the navigation data from the navigation satellite 12 with the navigation data provided by the signals transmitted by the navigation satellite, such as by being interleaved with ranging signals transmitted by the navigation satellite as described above in conjunction with block 30. Additionally or alternatively, the navigation device may receive navigation data from an assisted-GNSS service. In this regard, assisted-GNSS recognizes that the ranging codes transmitted by a navigation satellite would generally be received by a GNSS receiver 28, even in relatively weak signal conditions, but that the navigation data interleaved with the ranging codes may become too noisy and erroneous for successful demodulation in certain circumstances, such as in an urban environment. As such, assisted-GNSS technology utilizes a global monitoring network for capturing the navigation data transmitted by navigation satellites and for providing at least some of the navigation data to a GNSS receiver as assistance data, such as via the Internet or other terrestrial communication systems or networks. In one example, an assisted GNSS Positioning service may provide GNSS assistance data, such as via, e.g., the HERE GNSS API from HERE Technologies that provides correction and assistance data including predicted assistance data.

Assistance data generally includes a set of information elements carrying navigation data from a navigation satellite 12 and optionally information identifying a reference location and a reference time. Access to the assistance data and potentially to additional information, such as the reference frequency of a modem utilized by the GNSS receiver 28, by the apparatus 20, such as the processing circuitry 22, may improve the performance of the navigation device 10. For example, the availability of assistance data may permit the time-to-first-fix to be reduced. Recognizing the importance of assistance data to GNSS performance, the lifetime of assistance data has been extended and the assistance data has become more readily available to GNSS receivers, both in the form of online assistance data as well as offline assistance data. In this regard, offline assistance data can be utilized even in instances in which there would otherwise have been a delay in establishing a network connection to obtain online assistance data or an inability to establish a network connection to obtain online assistance data, such as in an instance in which the requisite roaming data plan is not available.

Additionally, the navigation device 10 may receive the correction data from a correction service. In this regard, the accuracy of the predictions of the position of a navigation satellite 12 beyond the lifetime of the ephemeris data that are provided by, for example, ephemeris extension is increasingly diminished as more time passes since the expiration of the lifetime of the most recent ephemeris data. To improve the performance of GNSS positioning, the position of the navigation satellite at different points in time that is predicted based upon ephemeris extension can be corrected. However, the determination of the correction of the predicted position of the navigation satellite may require more computational capacity than a device that incorporates the GNSS receiver may desire to dedicate to position determination. These limitations on the computational capacities of a device that are available to determine corrections to the predicted position of a navigation satellite may become more prevalent as GNSS receivers are incorporated in more consumer grade devices that may have a limited computational capacity, such as IoT devices.

Although the correction data may be provided in various manners, the correction data of one example embodiment is provided by a precise point positing (PPP) technique that utilizes a network of reference stations to determine corrections to satellite orbits and clocks. The PPP technique may also provide code biases, phase biases, and/or corrections for atmospheric errors, such as ionospheric and/or tropospheric corrections, although other embodiments may utilize fixed code biases, phase biases and/or corrections for atmospheric errors, with the fixed correction data being changed from time to time. The correction data may be provided in a state space, such as in a state space representation (SSR) format that separates the corrections into different components depending upon the source of the error, such as the orbit, the clock, the ionosphere model, etc. The correction data in the state space may be converted in one example embodiment into an observation space (OSR) with the resulting corrections utilized to correct individual observations. For example, the separate SSR corrections may be converted into the observation space and then summed to provide a single OSR correction per signal from a navigation satellite 12.

Based on the navigation data and the correction data, e.g., SSR corrections, the apparatus 20 of an example embodiment also includes means, such as the processing circuitry 22 or the like, for determining a virtual observation for the parameter, that is, the same parameter for which a measurement was obtained based on signals transmitted by the navigation satellite 12 received by the navigation device 10. See block 36 of FIG. 3 and block 54 of FIG. 4. In this regard, the virtual observation is determined for the navigation device being located at the estimated position. For example, the virtual observation may be a virtual pseudorange between the navigation satellite and the navigation device, a virtual carrier phase of the signals or a virtual doppler shift of the signals. With reference to a virtual pseudorange, the apparatus, such as a processing circuitry, may be configured to determine the corrected position of the navigation satellite at a particular point in time based upon the navigation data and the correction data and, as a result, may also determine the virtual pseudorange between the corrected position of the navigation satellite and the estimated position of the navigation device.

Although the apparatus 20, such as the processing circuitry 22, may be configured to determine the virtual pseudorange in various manners, the apparatus, such as the processing circuitry, of an example embodiment is configured to determine the virtual pseudorange ρ_{VRS}^{s} to satellite s as follows:

ρ_{VRS}^{s}=r^{s}+OSR^{s}+∈^{s}

wherein s designates a particular satellite from among the plurality of navigation satellites visible to the navigation device 10, r^{s} is the true geometric distance between virtual navigation device, that is, the navigation device located at the estimated position, and the navigation satellite s, OSR^{s} is the total correction calculated in observation space for satellite s, that is, the single OSR correction per signal from the navigation satellite s, and ∈^{s} represents other possible error sources not modelled by OSR, such as the Earth's rotational correction and the receiver noise. Although the foregoing equation designates the satellite from among a plurality of visible navigation satellites to be satellite s, the designation s need not be utilized in an instance in which foregoing equation is utilized for a single satellite. Also, the foregoing discussion including the equation relates to one example of a technique for determining a virtual pseudorange. Additionally or alternatively, the apparatus, such as the processing circuitry, of another example embodiment may be configured to determine one or more other virtual observations, e.g., virtual parameters.

As shown in block 38 of FIG. 3, the apparatus 20 of an example embodiment may also include means, such as the processing circuitry 22 or the like, for determining whether the signals transmitted by the navigation satellite 12 and received by the navigation device 10 include multipath signals 15. This determination is based upon the measurement of the parameter and the virtual observation for the same parameter. In an example embodiment, the apparatus, such as the processing circuitry, is configured to determine whether the signals transmitted by the navigation satellite and received by the navigation device include multipath signals by comparing a difference between the measurement of the parameter and the virtual observation for the parameter to a threshold. See, for example, blocks 56 and 58 of FIG. 4 in which the observations are compared to the virtual observations and a determination is then made based upon decision logic of the apparatus and, more particularly, the processing circuitry, as to whether the signals transmitted by the navigation satellite and received by the navigation device include multipath signals. As shown in conjunction with block 58, the decision logic may also consider other relevant data in determining whether the signals transmitted by the navigation satellite and received by the navigation device include multipath signals. The decision logic may be configured to consider any of a wide variety of other relevant data including the noise level of the signals received by the navigation device which results in some loss of power, the suddenness of any changes in measurements such as a sudden change in a pseudorange measurement that may be caused by a line-of-sight signal changing to a multipath signal, a quality indicator available from the navigation device or from the broadcasted navigation signals, real-time integrity information from assistance-data services and/or the accumulated delta range (ADR), multipath flags and/or uncertainty values provided by a navigation device.

By way of example, a virtual pseudorange as determined for the navigation device 10 is based upon a direct line-of-sight between the navigation satellite 12 and the navigation device as defined by the distance between the estimated position of the navigation satellite and the estimated position of the navigation device. In contrast, a pseudorange between the navigation satellite and the navigation device may be impacted by one or more multipath signals 15 that reflect from a surface while travelling from a navigation satellite to the navigation device, thereby resulting in a pseudorange that is greater than the virtual pseudorange.

In some example embodiments, the threshold may be a predefined threshold. In other embodiments, however, the threshold is an adaptive threshold having a value that depends upon one or more factors. For example, the adaptive threshold may vary depending upon the signal quality of the signals received by a navigation device 10 from the navigation satellite 12 with the threshold having an inverse relationship to the signal quality. In this regard, in an instance in which the signals received by the navigation device from the navigation satellite have a high signal quality, the adaptive threshold may have a relatively small value. In comparison, in an instance in which the signal quality of the signals transmitted by the navigation satellite and received by the navigation device have a low signal quality, the adaptive threshold may have a greater value. As such, the threshold may be adapted or tuned dependent upon the type of navigation device, such as the type of GNSS receiver, that receives the signals and/or based on one or more characteristics of a specific navigation device. Additionally or alternatively, the adaptive threshold may be based upon the number of navigation satellites of a constellation transmitting signals that are received by the navigation device with the threshold having an inverse relationship to the number of navigation satellites. In this regard, in an instance in which the signals received by the navigation device originate with a larger number of navigation satellites, the adaptive threshold may have a relatively small value. In comparison, in an instance in which the signals received by the navigation device originate with a smaller number of navigation satellites, the adaptive threshold may have a greater value.

While the measurement of the parameter and the virtual observation for the parameter may be determined at a single instance in time, the apparatus 20, such as the processing circuitry 22, of an example embodiment may be configured to obtain measurements of the parameter and to determine virtual observations for the parameter over a period of time. In this example embodiment, the measurement of the parameter is repeatedly obtained over a period of time and the virtual observation for the parameter is also repeatedly determined over the same period of time. For example, the measurement of the parameter may be repeatedly obtained during a predefined period of time and the virtual observation for the same parameter may be repeatedly determined over the same predefined period of time. In this example embodiment, the apparatus, such as the processing circuitry, is configured to compare the difference between the measurement of the parameter and the virtual observation for the parameter by comparing, for example, the difference between an average of the measurement of the parameter obtained over time, such as over the predefined period of time, and the average of the virtual observation for the parameter determined over time, such as over the same predefined period of time, to the threshold.

In an instance in which the signals transmitted by the navigation satellite 12 and received by the navigation device 10 are determined to include multipath signals 15, such as in an instance in which the comparison of the difference between the measurement of the parameter and the virtual observation for the parameter fails to satisfy the threshold, such as by exceeding the threshold, the apparatus 20 may also be configured to take one or more predefined actions. See block 40 of FIG. 3 and block 60 of FIG. 4. In contrast, in an instance in which the comparison of the difference between the measurement of the parameter and the virtual observation for the parameter is determined to satisfy the threshold, such as by being less than the threshold, the apparatus, such as the processing circuitry 22, may be configured to utilize the signals received from the navigation satellite including the measurement of the parameter based on the signals and the estimated position of the navigation device in conjunction with the determination of the position of the navigation device since the signals transmitted by the navigation satellite and received by the navigation device have not been determined to be multipath signals and should, instead, allow for the position of the navigation device to be determined in an accurate manner. See block 42.

In an instance in which the signals transmitted from the navigation satellite 12 to the navigation device 10 are identified to include multipath signals 15, various actions may be taken. In an example embodiment, the apparatus 20 includes means, such as the processing circuitry 22, the communication interface 26 or the like, for causing a warning indication to be provided in response to signals transmitted by the navigation satellite and received by the navigation device being determined to include multipath signals. By providing the warning indication, reliance upon the position of the navigation device as determined based upon the multipath signals may be indicated to be potentially unreliable and/or inaccurate, at least relative to the position of the navigation device as determined utilizing line-of-sight signals from the navigation satellite to the navigation device. Although a warning indication may be utilized in conjunction with a variety of different applications including a variety of different navigation applications or systems, one application in which a warning indication may be provided involves a vehicle that carries the navigation device and that operates in accordance with an autonomous mode or a semi-autonomous mode. In response to receiving the warning indication, the vehicle and/or the driver of the vehicle may change the mode of operation to a manual mode in which the driver fully controls the operation of the vehicle or may at least more closely monitor the performance of a vehicle in an autonomous mode or a semi-autonomous mode.

Alternatively, the action taken in response to determining that the signal transmitted by the navigation satellite 12 and received by the navigation device 10 includes multipath signals 15 may include the determination of a refined position. In this example embodiment, the apparatus 20 includes means, such as the processing circuitry 22 or the like, for determining the refined position of the navigation device based upon signals transmitted by a plurality of navigation satellites and received by the navigation device, without consideration the signals transmitted by the navigation satellite that were determined to include multipath signals. In this regard, the apparatus, such as the processing circuitry, may be configured to separately determine for each navigation satellite for which the navigation device receives signals whether the signals transmitted by the respective navigation satellite and received by the navigation device include multipath signals. In this example embodiment, the apparatus, such as the processing circuitry, is therefore configured to utilize only the signals transmitted by the navigation satellites and received by the navigation device that are not determined to include multipath signals in conjunction with the determination of the refined position. As such, the apparatus, such as the processing circuitry, of this example embodiment is correspondingly configured not to take into account the signals transmitted by the navigation satellite and received by the navigation device that have been determined multipath signals.

As the determination of the position of a navigation device is dependent upon the navigation device 10 receiving signals from at least a predefined number of navigation satellites, such as at least four navigation satellites, the apparatus 12, such as the processing circuitry 12, of this example embodiment may be configured to determine the refined position based only upon the signals transmitted by the navigation satellites that are received by the navigation device that were determined not to include multipath signals 15 in an instance in which at least the predefined number of navigation satellites are determined to transmit signals that are received by the navigation device and are determined not to include multipath signals. By way of example, in an instance in which ten navigation satellites transmit signals that are received by the navigation device with the signals transmitted by three of those ten navigation satellites being determined to include multipath signals, the apparatus, such as the processing circuitry, may determine the refined position of the navigation device based only upon the seven navigation satellites for which the signals that they transmit and that are received by the navigation device do not include multipath signals with the signals transmitted by the three navigation satellites that do include multipath signals being ignored for purposes of the determination of the redefined decision.

However, in an instance in which the number of navigation satellites 12 that are determined to transmit signals that are received by the navigation device 10 and are determined not to include multipath signals 15 is less than the predefined number, such as less than four, the apparatus 20, such as the processing circuitry 22, may be configured to determine the position of the navigation device in reliance upon multipath signals from one or more of the navigation satellites. In this regard, the apparatus, such as the processing circuitry, may be configured to determine the position of the navigation device based upon the signals received from all of the navigation satellites or from a subset of the navigation satellites, such as the predefined number of navigation satellites, that are least influenced by multipath signals, such as by having the least deviation between the measurement of the parameter and the virtual observation for the parameter to a threshold. In an instance in which the determination of the position of the navigation device is at least partly dependent upon multipath signals transmitted by a navigation satellite, the apparatus, such as the processing circuitry, the communication interface 26 or the like, may also be configured to provide a warning indication of potential inaccuracies associated with the position of the navigation device as a result of the at least partial reliance upon multipath signals.

In an instance in which the signals transmitted by at least some of the navigation satellites 12 are determined to be multipath signals 15, the apparatus 20, such as the processing circuitry 22, of another example embodiment is configured to determine the refined position of the navigation device 10 in accordance with a different positioning technique that does not rely upon the signals transmitted by the navigation satellites or at least without reliance upon the signals transmitted by the navigation satellite(s) that are determined to be multipath signals. In this example embodiment, the apparatus, such as processing circuitry, may be configured to determine the refined position utilizing any of a variety of different positioning techniques, including, for example, network positioning techniques or WiFi positioning techniques.

In a further example embodiment, the refined position is based in part upon compensation for the delay introduced by the reflection of the multipath signals 15. For example, the apparatus 20 of this example embodiment includes means, such as the processing circuitry 22 or the like, for compensating for the delay introduced into the signals transmitted by the navigation satellite 12 and received by the navigation device 10 as a result of the multipath propagation of the signals that were determined to comprise multipath signals. Compensation for the delay may be provided in various manners including, for example, based on the difference between virtual observations and real observations and/or based on differential weighting of signals received by a navigation device depending on whether a signals is a multipath signal, such as by weighting a multipath signal with a relatively small weight. If a multipath signal is weighted with a value of zero, the corresponding signal is effectively ignored. The apparatus of this example embodiment also includes means, such as the processing circuitry or the like, for determining a refined position of the navigation device based upon the signals transmitted by the navigation satellite following compensation for the delay introduced for the multipath propagation. In this example embodiment, the position of the navigation device therefore relies upon the signals transmitted by the navigation satellite and received by the navigation device including the multipath signals, albeit following compensation for the delay introduced into the signals as a result of the reflection of the multipath signals, so as to reduce or eliminate inaccuracies otherwise introduced into the position determination by the multipath signals.

By identifying signals transmitted from a navigation satellite 12 and received by a navigation device 10 that includes multipath signals 15, the method, apparatus 20 and computer program product of an example embodiment may take appropriate action, such as by reducing or eliminating inaccuracies that may otherwise be introduced by reliance upon multipath signals in conjunction with the determination of the position of the navigation device. As such, the position of the navigation device may be more accurately defined, particularly in environments in which signals transmitted by the navigation satellite and received by the navigation device have an opportunity to reflect from a surface, such as the surface of a building 14, a body of water or the like.

Additionally, the method, apparatus 20 and computer program product of an example embodiment are configured to advantageously determine that the signals transmitted by a navigation satellite and received by the navigation device include multipath signals 15 in an efficient manner so as not to require substantial computing resources and/or access to a large data base including, for example, a data base having a three dimensional map of a region including three dimensional models of the buildings within the region. Additionally, the method, apparatus and computer program product of an example embodiment can determine the signals transmitted by a navigation satellite and received by a navigation device include multipath signals and can then take an appropriate action without requiring that the GNSS receiver 28 to have a specific type of antenna and/or without access to the underlying signal processing algorithms. As such, the method, apparatus and computer program product may benefit a number of GNSS receivers including those having lower quality antennas and correspondingly large measurement noise, such as consumer-grade GNSS receivers including those included in many mobile phones.

As described above, FIGS. 3 and 4 are flowcharts of an apparatus 20, method, and computer program product configured to detect multipath signals 15 from one or more navigation satellites 12 and to take appropriate action based on such a determination according to an example embodiment. It will be understood that each block of the flowcharts, and combinations of blocks in the flowcharts, may be implemented by various means, such as hardware, firmware, processing circuitry 22, and/or other devices associated with execution of software including one or more computer program instructions. For example, one or more of the procedures described above may be embodied by computer program instructions. In this regard, the computer program instructions which embody the procedures described above may be stored by the memory device 24 of the apparatus and executed by the processing circuitry or the like. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for detecting multipath signals from a navigation satellite, the method comprising:
obtaining a measurement of a parameter based on signals transmitted by the navigation satellite and received by a navigation device;
determining an estimated position of the navigation device upon receiving the signals;
based on navigation data regarding a position of the navigation satellite and correction data regarding a correction to the position of the navigation satellite, determining a virtual observation for the parameter, wherein the virtual observation is determined for the navigation device being located at the estimated position; and
determining whether the signals transmitted by the navigation satellite and received by the navigation device comprise multipath signals based upon the measurement of the parameter and the virtual observation for the parameter.

2. A method according to claim 1, wherein the parameter comprises one or more of a pseudorange between the navigation satellite and the navigation device, a carrier phase of the signals or a doppler shift of the signals.

3. A method according to claim 1, wherein determining whether the signals transmitted by the navigation satellite and received by the navigation device comprise multipath signals comprises comparing a difference between the measurement of the parameter and the virtual observation for the parameter to a threshold.

4. A method according to claim 3, wherein the measurement of the parameter is repeatedly obtained over time and the virtual observation for the parameter is repeatedly determined over time, and wherein comparing the difference comprises comparing (i) a difference between an average of the measurement of the parameter obtained over time and an average of the virtual observation for the parameter determined over time to (ii) the threshold.

5. A method according to claim 3, wherein the threshold comprises an adaptive threshold at least partially based upon one or more of a quality of the signals received by a navigation device from the navigation satellite, a type of navigation device, one or more characteristics of the navigation device or a number of navigation satellites of a constellation transmitting signals that are received by the navigation device.

6. A method according to claim 1, further comprising causing a warning indication to be provided in response to the signals transmitted by the navigation satellite and received by the navigation device being determined to comprise multipath signals.

7. A method according to claim 1, further comprising determining a refined position of the navigation device based upon signals transmitted by a plurality of navigation satellites and received by the navigation device but without consideration of the signals transmitted by the navigation satellite that were determined to comprise multipath signals.

8. A method according to claim 1, further comprising:
compensating for a delay introduced into the signals transmitted by the navigation satellite and received by the navigation device as a result of multipath propagation of the signals that were determined to comprise multipath signals; and
determining a refined position of the navigation device based upon the signals transmitted by the navigation satellite following compensation for the delay introduced by the multipath propagation.

9. A method according to claim 1, further comprising determining a refined position of the navigation device in accordance a different positioning technique that does not rely upon the signals transmitted by the navigation satellite in an instance in which the signals transmitted by the navigation satellite are determined to comprise multipath signals.

10. An apparatus configured to detect multipath signals from a navigation satellite, the apparatus comprising processing circuitry and at least one non-transitory memory including computer program code instructions stored therein, the computer program code instructions configured to, when executed by the processing circuitry, cause the apparatus at least to:
obtain a measurement of a parameter based on signals transmitted by the navigation satellite and received by a navigation device;
determine an estimated position of the navigation device upon receiving the signals;
based on navigation data regarding a position of the navigation satellite and correction data regarding a correction to the position of the navigation satellite, determine a virtual observation for the parameter, wherein the virtual observation is determined for the navigation device being located at the estimated position; and
determine whether the signals transmitted by the navigation satellite and received by the navigation device comprise multipath signals based upon the measurement of the parameter and the virtual observation for the parameter.

11. An apparatus according to claim 10, wherein the parameter comprises one or more of a pseudorange between the navigation satellite and the navigation device, a carrier phase of the signals or a doppler shift of the signals.

12. An apparatus according to claim 10, wherein the computer program code instructions are configured to, when executed by the processing circuitry, cause the apparatus to determine whether the signals transmitted by the navigation satellite and received by the navigation device comprise multipath signals by comparing a difference between the measurement of the parameter and the virtual observation for the parameter to a threshold.

13. An apparatus according to claim 12, wherein the measurement of the parameter is repeatedly obtained over time and the virtual observation for the parameter is repeatedly determined over time, and wherein the computer program code instructions are configured to, when executed by the processing circuitry, cause the apparatus to compare (i) the difference by comparing a difference between an average of the measurement of the parameter obtained over time and an average of the virtual observation for the parameter determined over time to (ii) the threshold.

14. An apparatus according to claim 12, wherein the threshold comprises an adaptive threshold at least partially based upon one or more of a quality of the signals received by a navigation device from the navigation satellite, a type of navigation device, one or more characteristics of the navigation device or a number of navigation satellites of a constellation transmitting signals that are received by the navigation device.

15. An apparatus according to claim 10, wherein the computer program code instructions are further configured to, when executed by the processing circuitry, cause the apparatus to cause a warning indication to be provided in response to the signals transmitted by the navigation satellite and received by the navigation device being determined to comprise multipath signals.

16. An apparatus according to claim 10, wherein the computer program code instructions are further configured to, when executed by the processing circuitry, cause the apparatus to determine a refined position of the navigation device based upon signals transmitted by a plurality of navigation satellites and received by the navigation device but without consideration of the signals transmitted by the navigation satellite that were determined to comprise multipath signals.

17. An apparatus according to claim 10, wherein the computer program code instructions are further configured to, when executed by the processing circuitry, cause the apparatus to:
compensate for a delay introduced into the signals transmitted by the navigation satellite and received by the navigation device as a result of multipath propagation of the signals that were determined to comprise multipath signals; and
determine a refined position of the navigation device based upon the signals transmitted by the navigation satellite following compensation for the delay introduced by the multipath propagation.

18. An apparatus according to claim 10, wherein the computer program code instructions are further configured to, when executed by the processing circuitry, cause the apparatus to determine a refined position of the navigation device in accordance a different positioning technique that does not rely upon the signals transmitted by the navigation satellite in an instance in which the signals transmitted by the navigation satellite are determined to comprise multipath signals.

19. A computer program product configured to detect multipath signals from a navigation satellite, the computer program product comprising at least one non-transitory computer-readable storage medium having computer-executable program code instructions stored therein, the computer-executable program code instructions comprising program code instructions configured to:
obtain a measurement of a parameter based on signals transmitted by the navigation satellite and received by a navigation device;
determine an estimated position of the navigation device upon receiving the signals;
based on navigation data regarding a position of the navigation satellite and correction data regarding a correction to the position of the navigation satellite, determine a virtual observation for the parameter, wherein the virtual observation is determined for the navigation device being located at the estimated position; and
determine whether the signals transmitted by the navigation satellite and received by the navigation device comprise multipath signals based upon the measurement of the parameter and the virtual observation for the parameter.

20. A computer program product according to claim 19, wherein the program code instructions configured to determine whether the signals transmitted by the navigation satellite and received by the navigation device comprise multipath signals comprise program code instructions configured to compare a difference between the measurement of the parameter and the virtual observation for the parameter to a threshold.
